(19) United States
(12) Patent Application Publication
(10) Pub. No.: US 2025/0100824 A1
(43) Pub. Date: Mar. 27, 2025

(54) MEDIUM STACKING DEVICE AND IMAGE FORMING APPARATUS

(71) Applicant: FUJIFILM Business Innovation Corp., Tokyo (JP)

(72) Inventor: Teruki NAGANUMA, kanagawa (JP)

(73) Assignee: FUJIFILM Business Innovation Corp., Tokyo (JP)

(21) Appl. No.: 18/593,986

(22) Filed: Mar. 4, 2024

(30) Foreign Application Priority Data
Sep. 25, 2023 (JP) 2023-161723

(51) Int. Cl. B65H 3/08; H04N 1/00

(52) U.S. Cl. CPC B65H 3/08; H04N 1/00909; B65H 2801/03

(57) ABSTRACT

A medium stacking device includes a supply unit configured to supply air to a plurality of stacked recording media from an edge side of the recording media to make the recording media float and separated, an image capturing unit configured to capture an image of the plurality of recording media to which air is supplied by the supply unit from the edge side, a moving unit configured to move in response to a moving operation by a user, and a cleaning unit configured to clean the image capturing unit in conjunction with the movement of the moving unit.

### CROSS-REFERENCE TO RELATED APPLICATIONS

This application is based on and claims priority under 35 USC 119 from Japanese Patent Application No. 2023-161723 filed Sep. 25, 2023.

### BACKGROUND

### (i) Technical Field

The present disclosure relates to a medium stacking device and an image forming apparatus.

### (ii) Related Art

Japanese Unexamined Patent Application Publication No. 2015-24868 discloses a sheet supply apparatus comprising: a tray on which a stack of sheets, which is formed with a plurality of vertically stacked sheets, is capable of being placed; an air blowing section that blows air toward the stack of sheets placed on the tray to float at least a topmost sheet; a sucking and conveying section that sucks the topmost sheet floated by the air blowing section and conveys the topmost sheet in a prescribed conveying direction, the sucking and conveying section being disposed above the tray; a first light source that emits first slit light, which is strip shaped light having a component extending vertically, the first slit light crossing at least a first edge of a first sheet and a second edge of a second sheet below the first sheet, the first sheet and the second sheet being part of a plurality of floated sheets; an image capture section that captures an image of the first slit light emitted to the first sheet and the second sheet, the image capture section being oriented in an image capturing direction that is different, in a plane parallel to the first sheet and the second sheet, from a direction in which the first slit light is emitted from the first light source; a calculating section that calculates a vertical clearance between the first sheet and the second sheet according to the image of the first slit light, the image being captured by the image capture section; and an air amount adjusting section that adjusts an amount of air to be blown by the air blowing section, according to the vertical clearance between the first sheet and the second sheet, the vertical clearance being calculated by the calculating section.

### SUMMARY

A medium stacking device may be a medium stacking device including a supply unit that supplies air to a plurality of stacked recording media from an edge side of the recording media to make the recording media float and separated, an image capturing unit that captures an image of the plurality of recording media to which air is supplied by the supply unit from the edge side, a moving unit that moves in response to a moving operation by a user, and a cleaning unit that cleans the image capturing unit.

In a case where the medium stacking device requires a user to clean the image capturing unit by performing an operation of moving the cleaning unit separately from the moving operation of moving the moving unit, a large operation burden is imposed on the user.

Aspects of non-limiting embodiments of the present disclosure relate to reducing the operation burden on the user as compared with the case where the user cleans the image capturing unit by performing the operation of moving the cleaning unit separately from the moving operation of moving the moving unit.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a medium stacking device including a supply unit configured to supply air to a plurality of stacked recording media from an edge side of the recording media to make the recording media float and separated, an image capturing unit configured to capture an image of the plurality of recording medi a to which air is supplied by the supply unit from the edge side, a moving unit configured to move in response to a moving operation by a user, and a cleaning unit configured to clean the image capturing unit in conjunction with the movement of the moving unit.

### BRIEF DESCRIPTION OF THE DRAWINGS

Exemplary embodiments of the present disclosure will be described in detail based on the following figures, wherein:

FIG. 1 is a schematic view illustrating an image forming apparatus according to the present exemplary embodiment;

FIG. 2 is a perspective view of a medium feeding device according to the present exemplary embodiment;

FIG. 3 is a cross-sectional view of a supply unit of the medium feeding device according to the present exemplary embodiment;

FIG. 4 is a cross-sectional view illustrating a state in which air is supplied to a plurality of sheet members in the configuration illustrated in FIG. 3;

FIG. 5 is a perspective view illustrating a cleaning mechanism according to the present exemplary embodiment;

FIG. 6 is a diagram illustrating an operation of a cleaning member in the cleaning mechanism according to the present exemplary embodiment;

FIG. 7 is a diagram illustrating an operation of the cleaning member in the cleaning mechanism according to the present exemplary embodiment;

FIG. 8 is a diagram illustrating an operation of the cleaning member in the cleaning mechanism according to the present exemplary embodiment; and

FIG. 9 is a block diagram illustrating a hardware configuration of a control unit of the medium feeding device according to the present exemplary embodiment.

### DETAILED DESCRIPTION

Hereinafter, an example of an exemplary embodiment according to the present disclosure will be described with reference to the drawings. In the drawings, an arrow H indicates an apparatus up-down direction (vertical direction), an arrow W indicates an apparatus width direction (horizontal direction), and an arrow D indicates an apparatus depth direction (horizontal direction).

### <Image Forming Apparatus 100>

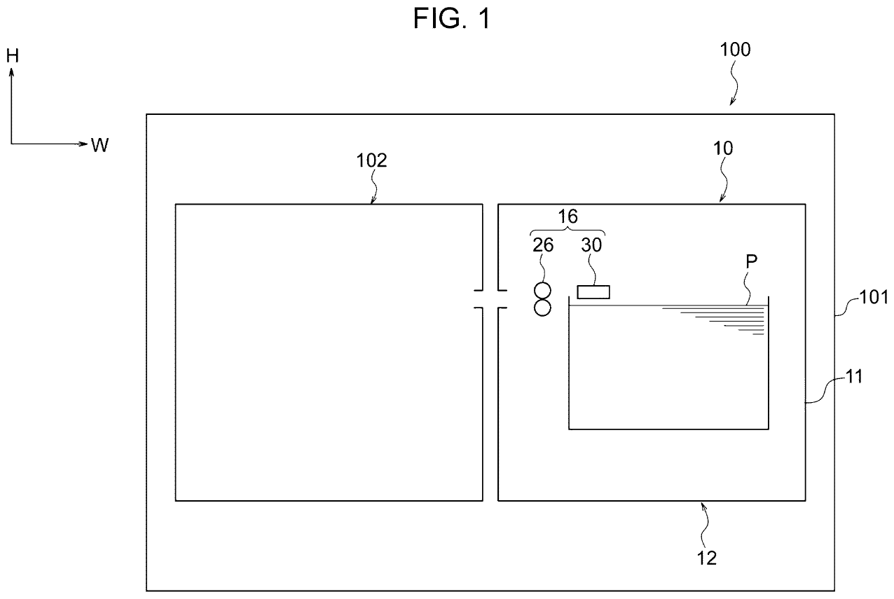

An image forming apparatus 100 is an apparatus that forms an image on a sheet member P, and as illustrated in FIG. 1, includes a medium feeding device 10 and an image forming unit 102. Note that the medium feeding device 10 may be a configuration provided in advance in an apparatus main body 101 of the image forming apparatus 100, or may be a configuration additionally attached to the apparatus main body 101 of the image forming apparatus 100 as an option or the like. The sheet member P is an example of a recording medium. The medium feeding device 10 is an example of a medium stacking device.

### <Image Forming Unit 102>

The image forming unit 102 illustrated in FIG. 1 is a component that forms an image on the sheet member P fed from the medium feeding device 10. For the image forming unit 102, for example, an electrophotographic image forming unit that forms an image on the sheet member P using toner is used.

The electrophotographic image forming unit performs, for example, charging, exposure, development, transfer, and fixing steps, to form an image on the sheet member P. Specifically, the electrophotographic image forming unit, for example, can form an image on the sheet member P by forming an image on a transfer member through charging, exposure, development, and transfer processes, transferring the image from the transfer member to the sheet member P, and then fixing the image on the sheet member P.

Note that an example of the image forming unit is not limited to the above-described electrophotographic image forming unit, and, for example, various image forming units such as an inkjet image forming unit may be used. The inkjet image forming unit, for example, forms an image on the sheet member P by discharging ink droplets onto the sheet member P from a discharging unit.

### <Medium Feeding Device 10>

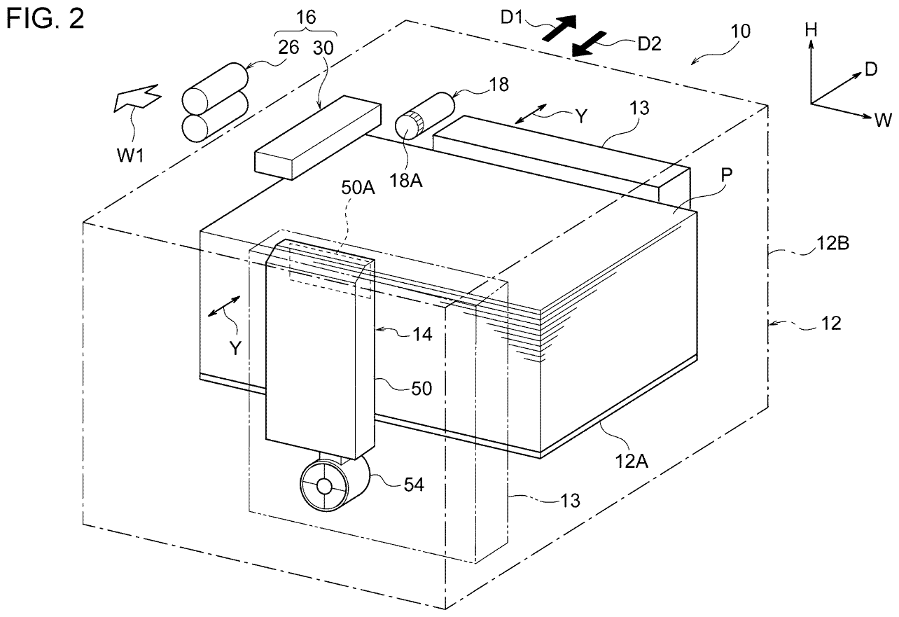

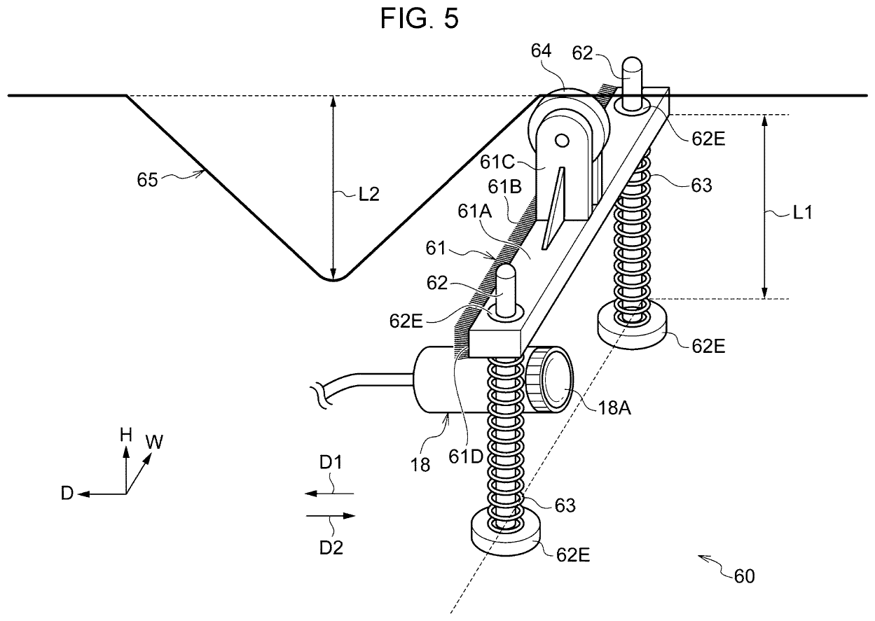

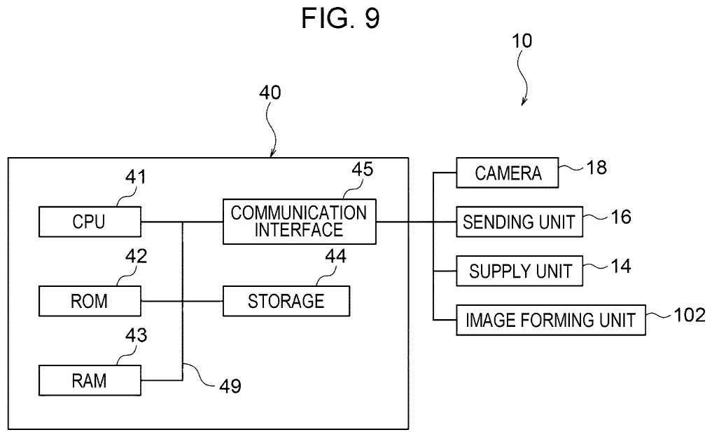

The medium feeding device 10 illustrated in FIG. 1 is a device that feeds the sheet member P toward the image forming unit 102. As illustrated in FIG. 2, the medium feeding device 10 includes a stacking unit 12, a feeding unit 16, and a camera 18. Furthermore, as illustrated in FIGS. 2, 3, and 4, the medium feeding device 10 includes side guides 13 and a supply unit 14. Furthermore, the medium feeding device 10 includes a cleaning mechanism 60, as illustrated in FIGS. 5, 6, 7, and 8. Furthermore, as illustrated in FIG. 9, the medium feeding device 10 includes a control unit 40. The stacking unit 12 is an example of a moving unit. The camera 18 is an example of an image capturing unit.

### <Stacking Unit 12 and Side Guide 13>

The stacking unit 12 is a component in which a plurality of the sheet members P are stacked and which is pulled out from and inserted into a device main body 11 (see FIG. 1) of the medium feeding device 10 by a user for replenishment of the sheet members P. As illustrated in FIG. 2, the stacking unit 12 includes a stacking unit main body 12B, a bottom plate 12A on which the plurality of sheet members P are stacked in a vertically stacked state, and an elevator device (not illustrated) that moves the bottom plate 12A up and down in the vertical direction.

The stacking unit main body 12B has a function of supporting each of the components provided in the stacking unit 12. In the present exemplary embodiment, the bottom plate 12A is supported by the stacking unit main body 12B to be vertically movable. The elevator device moves up the bottom plate 12A until the position of the topmost sheet member P of the sheet members P stacked on the bottom plate 12A reaches a predetermined height.

The stacking unit 12 is movable to a side of the sheet member P with respect to the device main body 11. Specifically, the stacking unit 12 (specifically, the stacking unit main body 12B) is attached to the device main body 11 (see FIG. 1) so as to be movable along the width direction of the sheet member P (the apparatus depth direction D in FIG. 2).

In the present exemplary embodiment, through manual user operations, the stacking unit 12 is pulled out from the device main body 11 (see FIG. 1) toward one side in the width direction (hereinafter, referred to as a pull-out direction D1), and after the sheet member P is replenished in the pulled-out state, is inserted into the device main body 11 toward the other side in the width direction (hereinafter, referred to as an insertion direction D2). In this manner, the stacking unit 12 functions as a moving unit that is moved by a user's moving operation. Note that the pull-out direction D1 is indicated by an arrow D1 in FIG. 2, and the insertion direction D2 is indicated by an arrow D2 in FIG. 2.

As illustrated in FIG. 2, the side guides 13 are components that come into contact with the side ends of the plurality of sheet members P from the lateral sides of the plurality of sheet members P. Specifically, the side guides 13 are disposed at the respective side ends on both sides of the sheet members P stacked on the bottom plate 12A. Thus, the side guides 13 are provided in pair. The pair of side guides 13 come into contact with both side ends of the sheet members P stacked on the bottom plate 12A (i.e., both edges of the sheet members P in the width direction (arrow Y direction)), thereby regulating the position of the sheet members P in the width direction.

### <Supply Unit 14>

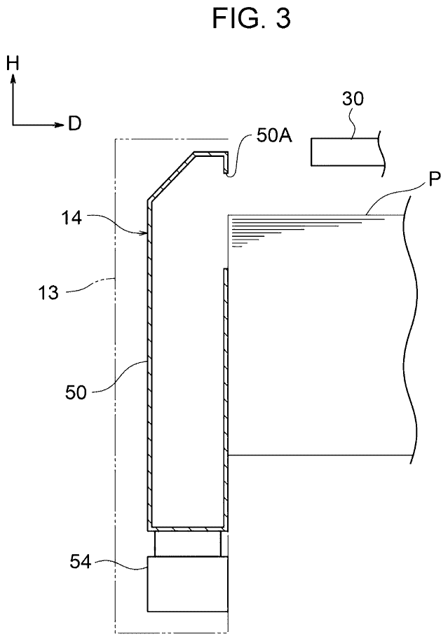

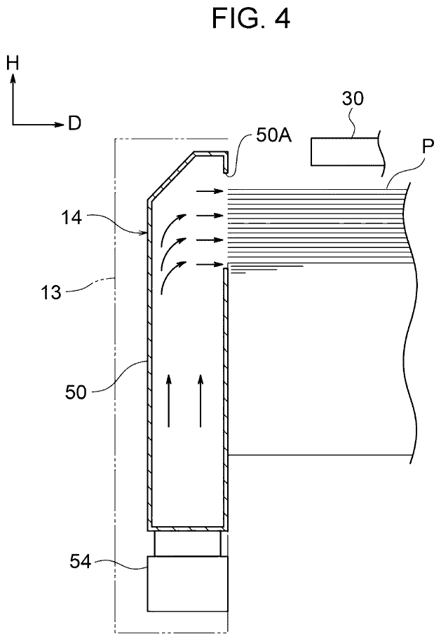

The supply unit 14 is a component that supplies air to the sheet members P from the edge sides of the plurality of sheet members P stacked on the stacking unit 12, to make the sheet members P float and separated. As illustrated in FIG. 2, the supply unit 14 is, for example, disposed inside one of the pair of side guides 13 (the closer side in the apparatus depth direction D in FIG. 2 (corresponding the insertion direction D2 side)). As illustrated in FIGS. 3 and 4, the supply unit 14 includes a duct 50 in which a supply port 50A is formed, and a blower 54 that supplies air into the duct 50.

As illustrated in FIGS. 3 and 4, the duct 50 extends vertically, and the supply port 50A is formed in an upper end portion of the duct 50 and on a side facing the stacked sheet members P. As illustrated in FIGS. 3 and 4, the blower 54 is disposed below the duct 50 and supplies air into the duct 50.

In the supply unit 14, as illustrated in FIG. 4, the air supplied into the duct 50 by the blower 54 rises inside the duct 50, and passes through the supply port 50A, to be supplied to the side end side (an example of the edge side) of the sheet member P. Then, the air is supplied between the sheet members P on the upper side among the plurality of sheet members P in the stacked state. Thus, the plurality of sheet members P are floated and separated.

In the present exemplary embodiment, the supply unit 14 supplies the air from one side end side (the closer side in the apparatus depth direction D in FIG. 2) of the plurality of sheet members P, but this should not be construed in a limiting sense. For example, the supply unit 14 may supply air from at least one of the other side end side (the far side in the apparatus depth direction D in FIG. 2), the leading end side (the downstream side in a feeding direction described later), and the trailing end side (the upstream side in the feeding direction described later) instead of or in addition to one side end side (the closer side in the apparatus depth direction D in FIG. 2) of the plurality of sheet members P.

### <Feeding Unit 16>

The feeding unit 16 is a component that feeds the topmost sheet member P separated by the supply unit 14 in the feeding direction (see an arrow W1 in FIG. 2). Specifically, as illustrated in FIG. 2, the feeding unit 16 is disposed above the topmost sheet member P of the plurality of sheet members P stacked on the bottom plate 12A of the stacking unit 12. The feeding unit 16 includes a sucking unit 30 and a feed roll 26.

The sucking unit 30 is disposed above a leading end portion of the topmost sheet member Pin the stacked state. Next, the sucking unit 30 sucks the floated topmost sheet member P and moves in the feeding direction (see arrow W1 in FIG. 2) in the sucking state, to convey the sheet member P in the feeding direction.

The feed roll 26 is disposed on the feeding direction side with respect to the sucking unit 30, receives the sheet member P conveyed by the sucking unit 30, and feeds the received sheet member P toward the image forming unit 102 (see FIG. 1).

### <Camera 18>

The camera 18 is a component that captures an image of the plurality of sheet members P, to which air is supplied by the supply unit 14, from the edge side. As illustrated in FIG. 2, the camera 18 is arranged on a side with respect to side end of the plurality of sheet members P (specifically, on the far side in the apparatus depth direction D (corresponding to the pull-out direction D1 side)).

In the present exemplary embodiment, the camera 18 captures, for example, a still image of the side end of the sheet member P from one side in the width direction (corresponding to the pull-out direction D1 side) of the sheet member P. The medium feeding device 10 includes a light source (not illustrated) that emits light to the side end of the plurality of sheet members P stacked in the stacking unit 12.

The camera 18 includes a lens 18A for forming an image of the sheet member P. The lens 18A is disposed at an end portion of the camera 18 in an image capturing direction. Note that the lens 18A is a cleaning target to be cleaned by the cleaning mechanism 60.

The camera 18 is provided to the stacking unit 12 (specifically, the stacking unit main body 12B), and moves integrally with the stacking unit 12 which is operated to be pulled out and inserted. That is, the camera 18 moves in the pull-out direction D1 together with the stacking unit 12 when the stacking unit 12 is manually pulled out from the device main body 11 (see FIG. 1) in the pull-out direction D1 by the user, and moves in the insertion direction D2 together with the stacking unit 12 when the stacking unit 12 is manually inserted into the device main body 11 in the insertion direction D2 by the user.

Note that the camera 18 is attached to the stacking unit 12 in a state of being positioned with respect to the stacking unit 12 (specifically, the stacking unit main body 12B) in the apparatus up-down direction, the apparatus width direction, and the apparatus depth direction.

### <Cleaning Mechanism 60>

The cleaning mechanism 60 illustrated in FIG. 5 is a mechanism that cleans the camera 18 using a cleaning member 61 in conjunction with the movement of the stacking unit 12. Specifically, as illustrated in FIG. 5, the cleaning mechanism 60 includes the cleaning member 61, a support body 62, a compression spring 63, and a roller 64 as a rotating body. The cleaning member 61 is an example of a cleaning unit.

The cleaning mechanism 60 is provided to the stacking unit 12 (specifically, the stacking unit main body 12B) illustrated in FIG. 2, and moves integrally with the stacking unit 12 operated to be pulled out and inserted. Thus, the parts (the cleaning member 61, the support body 62, the compression spring 63, and the roller 64) of the cleaning mechanism 60 are moved integrally with the stacking unit 12 in the pull-out direction D1 when the stacking unit 12 is manually pulled out from the device main body 11 (see FIG. 1) in the pull-out direction D1 by the user, and are moved integrally with the stacking unit 12 in the insertion direction D2 when the stacking unit 12 is manually inserted into the device main body 11 in the insertion direction D2 by the user.

The cleaning member 61 is a member that cleans the camera 18 (specifically, the lens 18A). Specifically, as illustrated in FIG. 5, the cleaning member 61 has a main body 61A, a brush 61B, and an attachment part 61C. The main body 61A has a length along the apparatus width direction W. The brush 61B is provided on a side surface 61D of the main body 61A in the pull-out direction D1.

The attachment part 61C extends upward from a central portion of the main body 61A in the longitudinal direction, and the roller 64 is rotatably mounted to an upper end portion of the attachment part 61C. The roller 64 is rotatable with the apparatus width direction W serving as a rotation axis direction.

The support body 62 is a component that supports the cleaning member 61 (specifically, the main body 61A) so as to be movable in the up-down direction. Specifically, a pair of the support bodies 62 are provided to be arranged in the stacking unit 12 at an interval in the apparatus width direction W. Each of the pair of support bodies 62 is formed by a pin (shaft portion) extending upward.

The pair of support bodies 62 are respectively inserted through of one end portion and the other end portion of the main body 61A in the longitudinal direction. The main body 61A is vertically movable between rings 62E fixed to the upper end portions and the lower end portions of the pair of support bodies 62.

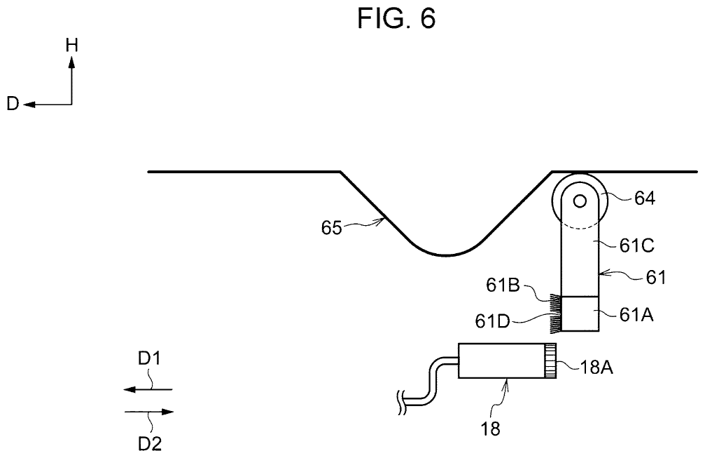

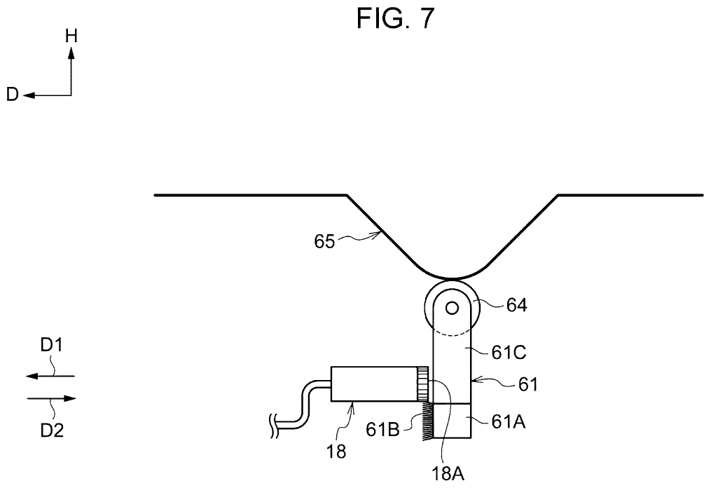

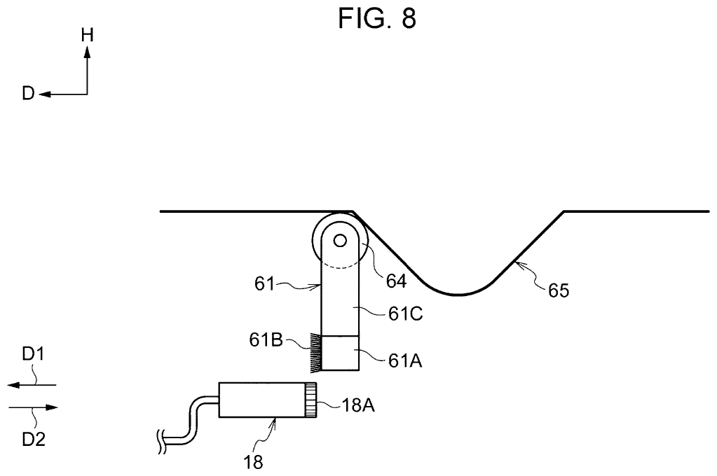

A movement range L1 of the cleaning member 61 in the up-down direction is set to be longer than a size of the camera 18 in the up-down direction, and the cleaning member 61 moves between an upper standby position (a position illustrated in FIGS. 6 and 8) on an upper side with respect to the camera 18 and a lower standby position (a position illustrated in FIG. 7) on a lower side with respect to the camera 18.

The compression spring 63 is attached to the support body 62 and presses the main body 61A upward. As a result, the cleaning member 61 is positioned at the upper standby position in a state where the stacking unit 12 is inserted in the device main body 11. Each of the upper standby position and the lower standby position of the cleaning member 61 is a non-contact position where the cleaning member 61 is not in contact with the camera 18, and is a position outside an image capturing region of the camera 18.

Therefore, in a state where the stacking unit 12 is inserted in the device main body 11, the cleaning member 61 is not in contact with the camera 18 and is positioned outside the image capturing region of the camera 18.

In the cleaning mechanism 60, a guide portion 65 that guides the roller 64 is provided in the device main body 11 (see FIG. 1) of the medium feeding device 10. The guide portion 65 is arranged at a position where the roller 64 passes when the stacking unit 12 operated to be pulled out and inserted moves. Furthermore, as illustrated in FIGS. 6, 7, and 8, the guide portion 65 is formed by a protruding portion that protrudes vertically, and guides the roller 64 such that the roller 64 vertically moves when the stacking unit 12 operated to be pulled out and inserted moves.

Thus, the cleaning member 61 moves between the upper standby position (the position illustrated in FIGS. 6 and 8) and the lower standby position (the position illustrated in FIG. 7) in conjunction with the movement of the stacking unit 12 operated to be pulled out and inserted. When the cleaning member 61 moves, the brush 61B vertically moves while being in contact with the lens 18A of the camera 18 and cleans the lens 18A. The movement range L1 of the cleaning member 61 is determined in advance by a vertical length L2 of the protruding portion that is the guide portion 65.

As described above, in the cleaning mechanism 60, the cleaning member 61 cleans the camera 18 in conjunction with both the movement of the stacking unit 12 for pulling out and the movement of the stacking unit 12 for insertion. In the present exemplary embodiment, the cleaning member 61 cleans the camera 18 by reciprocating while being in contact with the camera 18 while the movement of the stacking unit 12 for each of the pulling-out and the insertion is made once (see FIGS. 6, 7, and 8).

### <Control Unit 40>

As illustrated in FIG. 9, the control unit 40 includes a central processing unit (CPU) 41, a read only memory (ROM) 42, a random access memory (RAM) 43, a storage 44, and a communication interface (I/F) 45. The components are communicably connected to each other via a bus 49. The CPU 41 is an example of a processor.

The CPU 41 is a central processing unit, and executes various programs and controls each unit. The ROM 42 stores therein various programs including a control program and various types of data. The RAM 43 serves as a work area and temporarily stores therein programs or data. The storage 44 is configured by a storage medium such as a hard disk drive (HDD), a solid state drive (SSD), or a flash memory, and stores various programs including an operating system and various types of data. Note that the control program may be stored in the storage 44.

The communication interface 45 is an interface for the control unit 40 to communicate with the camera 18, the feeding unit 16, the supply unit 14 (specifically, the blower 54), the image forming unit 102, and the like. For example, a standard such as Ethernet (registered trademark), FDDI, or Wi-Fi (registered trademark) is used.

In the control unit 40, the CPU 41 reads various programs including the control program from the ROM 42 or the storage 44, and executes the programs using the RAM 43 as a work area. The CPU 41 controls the operation of the supply unit 14 by executing the control program. Specifically, in the present exemplary embodiment, for example, the supply amount of the supply unit 14 (specifically, the blower 54) is adjusted and the supply unit 14 is controlled to be stopped and activated, according to the clearance between the sheet members P the image of which is captured by the camera 18.

### Operation According to the Present Exemplary Embodiment

In the cleaning mechanism 60 according to the present exemplary embodiment, the cleaning member 61 cleans the camera 18 in conjunction with the movement of the stacking unit 12. Therefore, as compared with a case where the user cleans the camera 18 by performing an operation of moving the cleaning member 61 separately from a moving operation of moving the stacking unit 12, an operation burden on the user is reduced.

Specifically, in the present exemplary embodiment, the cleaning member 61 cleans the camera 18 in conjunction with the movement of the stacking unit 12 (an example of a moving unit) operated to be pulled out and inserted. Therefore, the frequency with which the camera 18 is cleaned is increased in accordance with the frequency at which the sheet members P are fed, as compared with a case where the moving unit is a moving unit on which the moving operation is performed by the user, regardless of the replenishment of the sheet members P.

Furthermore, in the present exemplary embodiment, the cleaning member 61 cleans the camera 18 in conjunction with both the movement of the stacking unit 12 for pulling out and the movement of the stacking unit 12 for insertion. Thus, as compared with a case where the cleaning member 61 is interlocked with only one of the movement of the stacking unit 12 for pulling out and the movement of the stacking unit 12 for insertion, the cleaning performance of the cleaning member 61 is improved.

Furthermore, in the present exemplary embodiment, the cleaning member 61 cleans the camera 18 by reciprocating while being in contact with the camera 18, while the movement the of stacking unit 12 for the pulling out or insertion is made once. For this reason, as compared with a case where the cleaning member 61 cleans the camera 18 by moving only in one way while being in contact with the camera 18 while the movement of the stacking unit 12 is made once, the cleaning performance of the cleaning member 61 is improved.

Furthermore, in the present exemplary embodiment, the camera 18 is provided to the stacking unit 12 (specifically, the stacking unit main body 12B), and moves integrally with the stacking unit 12 operated to be pulled out and inserted. For this reason, as compared with a case where the camera 18 is provided to the device main body 11 and the positional relationship with the sheet members P stacked on the stacking unit 12 changes in accordance with the movement of the stacking unit 12 pulled out, a focus shift at the time when the camera 18 captures the image of the plurality of sheet members P from the edge side is suppressed.

Furthermore, in the present exemplary embodiment, the cleaning member 61 is provided to the stacking unit 12, interlocked with the movement of the stacking unit 12 operated to be pulled out and inserted, and moves integrally with the stacking unit 12 while cleaning the camera 18. Therefore, as compared with a case where the cleaning member 61 is provided to the device main body 11 and remains in the device main body 11 when the stacking unit 12 is pulled out, the cleaning member 61 is easily replaced in a state where the stacking unit 12 is pulled out from the device main body 11.

Further, in the present exemplary embodiment, the cleaning member 61 is located at the non-contact position to be not in contact with the camera 18 in a state where the stacking unit 12 is inserted in the device main body 11. For this reason, deterioration of the cleaning member 61 is suppressed, as compared with a case where the cleaning member 61 is positioned at the contact position to be in contact with the camera 18 also in a state where the stacking unit 12 is inserted in the device main body 11.

Furthermore, in the present exemplary embodiment, the cleaning member 61 at the non-contact position is located outside the image capturing region of the image capturing unit. Therefore, as compared with a case where the cleaning member 61 at the non-contact position is located in the image capturing region of the camera 18, the cleaning member 61 is prevented from hindering the image capturing by the camera 18 capturing the image of the plurality of sheet members P from the edge side.

### <Modification>

In the present exemplary embodiment, the camera 18 is used as an example of the image capturing unit, but the present disclosure is not limited thereto. For example, the image capturing unit may be any component capable of capturing an image of the sheet members P, an example of which including a video or the like capturing a movie or the like.

In the present exemplary embodiment, as illustrated in FIG. 2, the camera 18 is disposed on the pull-out direction D1 side with respect to the plurality of stacked sheet members P, but the present disclosure is not limited thereto. For example, the camera 18 may be disposed on the insertion direction D2 side with respect to the sheet member P instead of or in addition to the pull-out direction D1 side with respect to the plurality of stacked sheet members P. In such a case, the cleaning mechanism 60 is also arranged on the insertion direction D2 side with respect to the sheet members P.

In the present exemplary embodiment, the stacking unit 12 is used as an example of the moving unit, but the present disclosure is not limited thereto. For example, the moving unit may be any component moving in response to the moving operation by the user, and may be the side guide 13. When the side guide 13 is used as the moving unit, the cleaning member 61 is configured to clean the camera 18 in conjunction with the movement of the side guide 13 by the user.

In addition, in the present exemplary embodiment, the cleaning member 61 is a member that performs cleaning using the brush 61B, but the present disclosure is not limited thereto. The cleaning member 61 may be a cleaning member formed by a sponge, a nonwoven fabric, or the like, and may be any member that can clean the image capturing unit such as the camera 18.

Further, in the present exemplary embodiment, the cleaning member 61 cleans the camera 18 in conjunction with both of the movement of the stacking unit 12 for the pulling out and the movement of the stacking unit 12 for the insertion, but the present disclosure is not limited thereto. For example, the cleaning member 61 may be configured to clean the camera 18 in conjunction with only one of the movement of the stacking unit 12 for the pulling out and the movement of the stacking unit 12 for the insertion. That is, in the present exemplary embodiment, the cleaning member 61 may be configured to clean the camera 18 in conjunction with at least one of the movement of the stacking unit 12 for the pulling out and the movement of the stacking unit 12 for the insertion.

Further, the cleaning member 61 cleans the camera 18 by reciprocating once while being in contact with the camera 18, while the movement of the stacking unit 12 for the pulling out or the insertion is made once, but the present disclosure is not limited thereto. For example, the cleaning member 61 may clean the camera 18 by reciprocating a plurality of times while being in contact with the camera 18, while the movement of the stacking unit 12 for the pulling out or the insertion is made once. In this case, the protruding portions corresponding to the number of times the cleaning member 61 reciprocates are formed in the guide portion 65. Specifically, when the cleaning member 61 reciprocates twice, two protruding portions are formed in the guide portion 65.

According to the configuration in which the cleaning member 61 cleans the camera 18 by reciprocating a plurality of times while being in contact with the camera 18 while the movement of the stacking unit 12 for pulling out or insertion is made once, the cleaning performance of the cleaning member 61 is improved as compared with a case where the cleaning member 61 cleans the camera 18 by reciprocating only once while being in contact with the camera 18, while the movement of the stacking unit 12 is made once.

Furthermore, the cleaning member 61 may be configured to clean the camera 18 by moving only one way while being in contact with the camera 18, while the movement of the stacking unit 12 is made once.

Further, in the present exemplary embodiment, the camera 18 and the cleaning mechanism 60 are provided to the stacking unit 12 (specifically, the stacking unit main body 12B), and the guide portion 65 is provided to the device main body 11, but the present disclosure is not limited thereto. For example, the camera 18 and the cleaning mechanism 60 may be provided to the device main body 11, and the guide portion 65 may be provided to the stacking unit 12. In this case, the cleaning mechanism 60 moves the cleaning member 61 to clean the camera 18 when the guide portion 65 moves in conjunction with the movement of the stacking unit 12 operated to be pulled out and inserted.

Further, in the present exemplary embodiment, the cleaning member 61 is located at the non-contact position where the cleaning member to be not in contact with the camera 18 in a state where the stacking unit 12 is inserted in the device main body 11, but the present disclosure is not limited thereto. For example, a configuration may be adopted in which the cleaning member 61 is located at a contact position to be in contact with the camera 18 also in a state where the stacking unit 12 is inserted in the device main body 11.

The present disclosure is not limited to the above-described exemplary embodiments, and various modifications, changes, and improvements can be made without departing from the spirit of the present disclosure. For example, a plurality of the modifications described above may be combined as appropriate.

In the above exemplary embodiment, the processor is a processor in a broad sense, and includes a general-purpose processor (for example, the above-described CPU or the like) and a dedicated processor (for example, a Graphics Processing Unit (GPU), Application Specific Integrated Circuit (ASIC), Field Programmable Gate Array (FPGA), a programmable logic device, or the like).

The operation of the processor in the above-described exemplary embodiment may be performed not only by one processor but also by a plurality of processors located at physically separated positions and cooperating with each other. Furthermore, the order of the operations of the processor is not limited to the order described in the above exemplary embodiment only, and may be appropriately changed.

### APPENDIX

(((1))) A medium stacking device comprising a supply unit configured to supply air to a plurality of stacked recording media from an edge side of the recording media to make the recording media float and separated, an image capturing unit configured to capture an image of the plurality of recording media to which air is supplied by the supply unit from the edge side, a moving unit configured to move in response to a moving operation by a user, and a cleaning unit configured to clean the image capturing unit in conjunction with the movement of the moving unit.
(((2))) The medium stacking device according to (((1))), further including a feeding unit configured to feed a topmost recording medium separated by the supply unit in a feeding direction, wherein the moving unit is a stacking unit on which the plurality of recording media are stacked, the stacking unit being operated by the user to be pulled out from and inserted into a device main body when the recording media are replenished, and the cleaning unit cleans the image capturing unit in conjunction with movement of the stacking unit on which the operations of pulling out from and inserting into the device main body are performed.
(((3))) The medium stacking device according to (((2))), wherein the cleaning unit cleans the image capturing unit in conjunction with both of the movement of the stacking unit pulled out and the movement of the stacking unit inserted.
(((4))) The medium stacking device according to (((2))) or (((3))), wherein the cleaning unit cleans the image capturing unit by reciprocating while being in contact with the image capturing unit, while the movement of the stacking unit for the pulling out or the insertion is made once.
(((5))) The medium stacking device according to (((4))), wherein the cleaning unit cleans the image capturing unit by reciprocating a plurality of times while being in contact with the image capturing unit, while the movement of the stacking unit for the pulling out or the insertion is made once.
(((6))) The medium stacking device according to any one of (((2))) to (((5))), wherein the image capturing unit is provided to the stacking unit, and moves integrally with the stacking unit on which the operations for the pulling out and the insertion are performed.
(((7))) The medium stacking device according to (((6))), wherein the cleaning unit is provided to the stacking unit, is interlocked with movement of the stacking unit on which the operations for the pulling out and the insertion are performed, and moves integrally with the stacking unit while cleaning the image capturing unit.
(((8))) The medium stacking device according to any one of (((2))) to (((7))), wherein in a state where the stacking unit is inserted in the device main body, the cleaning unit is located at a non-contact position where the cleaning unit is not in contact with the image capturing unit.
(((9))) The medium stacking device according to (((8))), wherein the cleaning unit at the non-contact position is located outside an image capturing region of the image capturing unit.
(((10))) An image forming apparatus comprising: the medium stacking device according to any one of (((1))) to (((9))); and an image forming unit configured to form an image on a recording medium fed from the medium stacking device.

What is claimed is:

1. A medium stacking device comprising:
a supply unit configured to supply air to a plurality of stacked recording media from an edge side of the recording media to make the recording media float and separated;
an image capturing unit configured to capture an image of the plurality of recording media to which air is supplied by the supply unit from the edge side;
a moving unit configured to move in response to a moving operation by a user; and
a cleaning unit configured to clean the image capturing unit in conjunction with the movement of the moving unit.

2. The medium stacking device according to claim 1, further comprising a feeding unit configured to feed a topmost recording medium separated by the supply unit in a feeding direction, wherein
the moving unit is a stacking unit on which the plurality of recording media are stacked, the stacking unit being operated by the user to be pulled out from and inserted into a device main body when the recording media are replenished, and
the cleaning unit cleans the image capturing unit in conjunction with movement of the stacking unit on which the operations of pulling out from and inserting into the device main body are performed.

3. The medium stacking device according to claim 2, wherein the cleaning unit cleans the image capturing unit in conjunction with both of movement of the stacking unit for the pulling out and movement of the stacking unit for the insertion.

4. The medium stacking device according to claim 2, wherein the cleaning unit cleans the image capturing unit by reciprocating while being in contact with the image capturing unit, while the movement of the stacking unit for the pulling out or the insertion is made once.

5. The medium stacking device according to claim 4, wherein the cleaning unit cleans the image capturing unit by reciprocating a plurality of times while being in contact with the image capturing unit, while the movement of the stacking unit for the pulling out or the insertion is made once.

6. The medium stacking device according to claim 2, wherein the image capturing unit is provided to the stacking unit, and moves integrally with the stacking unit on which the operations for the pulling out and the insertion are performed.

7. The medium stacking device according to claim 6, wherein the cleaning unit is provided to the stacking unit, is interlocked with movement of the stacking unit on which the operations for the pulling out and the insertion are performed, and moves integrally with the stacking unit while cleaning the image capturing unit.

8. The medium stacking device according to claim 2, wherein in a state where the stacking unit is inserted in the device main body, the cleaning unit is located at a non-contact position where the cleaning unit is not in contact with the image capturing unit.

9. The medium stacking device according to claim 8, wherein the cleaning unit at the non-contact position is located outside an image capturing region of the image capturing unit.

10. An image forming apparatus comprising:
the medium stacking device according to claim 1; and
an image forming unit configured to form an image on a recording medium fed from the medium stacking device.

11. An image forming apparatus comprising:
the medium stacking device according to claim 2; and
an image forming unit configured to form an image on a recording medium fed from the medium stacking device.

12. An image forming apparatus comprising:
the medium stacking device according to claim 3; and
an image forming unit configured to form an image on a recording medium fed from the medium stacking device.

13. An image forming apparatus comprising:
the medium stacking device according to claim 4; and
an image forming unit configured to form an image on a recording medium fed from the medium stacking device.

14. An image forming apparatus comprising:
the medium stacking device according to claim 5; and
an image forming unit configured to form an image on a recording medium fed from the medium stacking device.

15. An image forming apparatus comprising:
the medium stacking device according to claim 6; and
an image forming unit configured to form an image on a recording medium fed from the medium stacking device.

16. An image forming apparatus comprising:
the medium stacking device according to claim 7; and
an image forming unit configured to form an image on a recording medium fed from the medium stacking device.

17. An image forming apparatus comprising:
the medium stacking device according to claim 8; and
an image forming unit configured to form an image on a recording medium fed from the medium stacking device.

18. An image forming apparatus comprising:
the medium stacking device according to claim 9; and
an image forming unit configured to form an image on a recording medium fed from the medium stacking device.
